(19) United States
(12) Patent Application Publication
(10) Pub. No.: US 2024/0223062 A1
(43) Pub. Date: Jul. 4, 2024

(54) POWER SUPPLY DEVICE FOR A RADAR SENSOR, METHOD FOR SUPPLYING ENERGY TO A RADAR SENSOR, RADAR SENSOR AND MOTOR VEHICLE

(71) Applicant: Robert Bosch GmbH, Stuttgart (DE)

(72) Inventors: Aymen Landoulsi, Reutlingen (DE); Jens Haensel, Grafenau (DE); Michael Ott, Leonberg (DE); Philipp Ritter, Saarbruecken (DE); Stefan Motschenbacher, Dresden (DE)

(21) Appl. No.: 18/394,190

(22) Filed: Dec. 22, 2023

(30) Foreign Application Priority Data
Jan. 3, 2023 (DE) 10 2023 200 037.7

(51) Int. Cl. H02M 1/00; G01S 7/35; G01S 7/40

(52) U.S. Cl. CPC H02M 1/0003; G01S 7/35; G01S 7/4013

(57) ABSTRACT

Power supply for a radar sensor that periodically transmits sequences with radar signals. Prior to the commencement of the transmission of radar signals, the radar sensor can provide a trigger signal at a power supply device, whereupon the power supply device temporarily adjusts the control behavior for the supply voltage of the radar sensor.

### FIELD

The present invention relates to a power supply device for a radar sensor and a method for supplying power to a radar sensor. The present invention also relates to a radar sensor with such a power supply device and to a motor vehicle with a radar sensor.

### BACKGROUND INFORMATION

Radar sensors are increasingly being used in modern motor vehicles to detect objects in the vehicle's surroundings. For example, sequences of radar signals can be transmitted and reflections, known as radar echoes, can thereupon be received and analyzed. Intervals in which no radar signals are transmitted can be provided between the transmission of the radar signals. The energy requirement of the radar sensor is greater during the transmission of the radar signals than in the intervals in which no radar signals are transmitted.

For example, German Patent Application No. DE 10 2012 220 879 A1 describes a method for determining the distances and relative velocities of objects by means of frequency-modulated continuous wave radar (FMCW radar). Sequences of periodically repeating ramps are transmitted and the radar echoes of such sequences are evaluated.

### SUMMARY

The present invention discloses a power supply device for a radar sensor, a method for supplying power to a radar sensor, a radar sensor and a motor vehicle. Advantageous example embodiments of the present invention are disclosed herein.

According to an example embodiment of the present invention, the following is provided:

A power supply device for a radar sensor, comprising a voltage supply connection, an input interface and a control apparatus. The power supply device is designed to provide a supply voltage for the radar sensor at the voltage supply connection. The input interface is designed to receive a trigger signal from the radar sensor. In particular, the input interface can receive a trigger signal from the radar sensor if the operating status of the radar sensor changes. The control apparatus is designed to adjust a control for the supply voltage at the voltage supply connection. In particular, the control apparatus is designed to temporarily adjust the control for the supply voltage at the voltage supply connection if a trigger signal from the radar sensor has been received at the input interface.

Furthermore, according to an example embodiment of the present invention, the following is provided:

A radar system comprising a radar sensor and a power supply device according to the present invention. The radar sensor is designed to transmit radar signals, receive radar echoes of the transmitted radar signals and process the received radar echoes. The power supply device is designed to provide a supply voltage for the radar sensor at the radar sensor. The radar sensor is also designed to provide a trigger signal at the input interface of the power supply device if a predetermined operating state is set in the radar sensor.

Furthermore, according to an example embodiment of the present invention, the following is provided:

A motor vehicle comprising a radar system according to the present invention.

Finally, according to an example embodiment of the present invention, the following is provided:

A method for supplying power to a radar sensor, comprising a step of providing a supply voltage at the radar sensor, a step of receiving a trigger signal from the radar sensor and a step of temporarily adjusting a control for the supply voltage at the radar sensor if a trigger signal from the radar sensor has been received.

The present invention is based on the finding that radar sensors may not transmit radar signals continuously, but that it is generally intended to provide time intervals between the transmission of individual radar signals, during which intervals no radar signals are transmitted. The energy requirement of a radar sensor in the time intervals in which radar signals are transmitted differs from the energy requirement in the time intervals in which no radar signals are transmitted. If the radar sensor switches from an operating state in which no radar signals are transmitted to an operating state in which radar signals are transmitted and the energy requirement increases, this may have an effect on the stability of the supply voltage provided at the radar sensor. For example, there may be brief voltage drops in the supply voltage if the current consumption of the radar sensor increases at the commencement of the transmission of radar signals. Such fluctuations in the supply voltage may have an influence on the operating behavior of the radar sensor. For example, this can affect the detection of objects by the radar sensor.

It is therefore a feature of the present invention to take this finding into account and to provide the power supply of a radar sensor that can improve the stability of the supply voltage for the radar sensor. In particular, it is desirable to ensure the stability of the supply voltage if the radar sensor transitions from a phase in which no radar signals are transmitted to a phase in which radar signals are to be transmitted.

For this purpose, according to an example embodiment of the present invention, it is provided that the radar sensor signals the transition from an operating state with lower power consumption to an operating state with higher power consumption by means of a trigger signal. In particular, for example, the transition from a phase in which no radar signals are transmitted to a phase in which radar signals are to be transmitted can be signaled by such a trigger signal from the power supply device. The power supply device can thereupon intervene in a suitable manner in the control of the supply voltage for the radar sensor. This allows, for example, the control of the supply voltage to be temporarily adjusted in such a way that a sufficiently stable supply voltage can be provided at the radar sensor even if the power consumption in the radar sensor increases.

As will be explained in more detail below, the intervention in the control behavior of the power supply device can be carried out in various suitable ways. However, this intervention in the control behavior is only temporary, i.e. for a short time period after the signaling by the radar sensor by means of the trigger signal. Within this time period, the radar sensor can transition to the operating state in which radar signals are to be transmitted. The power supply device adjusts the control behavior for the supply voltage of the radar sensor in such a way that an increase in the current consumption by the radar sensor can be compensated for. In this way, a supply voltage which enables reliable and error-free operation of the radar sensor can always be provided at the radar sensor.

After the temporary adjustment of the control behavior as a result of the trigger signal, the power supply device can return to the original control behavior.

According to one embodiment of the present invention, the power supply device comprises a switching converter. The switching converter is designed to convert an input voltage provided at the power supply device into a predetermined output voltage. Furthermore, the switching converter is designed to provide the output voltage as a supply voltage at the voltage supply connection. In this way, an input voltage, in particular a DC input voltage, can be converted by means of the switching converter into an output voltage that is suitable for supplying the radar sensor with a corresponding electrical voltage. The switching converter can be controlled by means of the control apparatus.

According to one embodiment of the present invention, the control apparatus is designed to increase the supply voltage at the voltage supply connection if a trigger signal from the radar sensor has been received at the input interface. By temporarily increasing the supply voltage in this way, it is possible, for example, to at least partially compensate in advance for an expected voltage drop when the current consumption by the radar sensor increases. This ensures that the supply voltage for the radar sensor is always within the required voltage range.

According to one embodiment of the present invention, the control apparatus is designed to increase a control bandwidth of the control for the supply voltage at the voltage supply connection if a trigger signal from the radar sensor has been received at the input interface. In principle, any suitable measures can be taken to increase the control bandwidth. This makes it possible to compensate, as rapidly as possible, for fluctuations in the power supply that occur when the power consumption by the radar sensor increases.

According to one embodiment of the present invention, the control apparatus is designed to reset the control for the supply voltage at the voltage supply connection after a predetermined period of time after the control bandwidth has been increased. For example, the control bandwidth can be reset to the initial control bandwidth after the predetermined period of time. By resetting the control bandwidth, i.e. reducing the control bandwidth compared to the temporarily increased control bandwidth, it is possible to improve the stability of the control for the supply voltage in the further course.

According to one embodiment of the radar system of the present invention, the radar sensor is designed to transmit sequences of radar signals. A pause during which no radar signals are transmitted is provided between the individual sequences of radar signals. In this case, the radar sensor can be designed to provide a trigger signal at the input interface of the power supply device in each case prior to the transmission of a sequence of radar signals. This can signal to the power supply device that the radar sensor intends to transmit a further sequence of radar signals and that an increased energy requirement is needed for this. Accordingly, the power supply device can thereupon initiate the measures described above after receiving such a trigger signal, in order to ensure the stability of the power supply when switching to the new operating state for transmitting radar signals.

According to one embodiment of the present invention, the radar sensor comprises a frequency-modulated continuous wave radar (FMCW radar). Such radar systems are often used in motor vehicles in particular.

The above embodiments and developments can be arbitrarily combined with one another insofar as is reasonable. Further embodiments, developments, and implementations of the present invention also include combinations, even those not explicitly mentioned, of features of the present invention described above or in the following with regard to the exemplary embodiments. The person skilled in the art will in particular also add individual aspects as improvements or additions to the relevant basic form of the present invention.

### BRIEF DESCRIPTION OF THE DRAWINGS

Further features and advantages of the present invention will be explained in the following with reference to the figures.

FIG. 1 shows a schematic representation of a principle circuit diagram of a radar system comprising a power supply device according to one embodiment of the present invention.

FIG. 2 shows a principle circuit diagram of an error amplifier for a control apparatus of a power supply device according to one embodiment of the present invention.

FIGS. 3A and 3B show diagrams for illustrating the control in a power supply device according to one embodiment of the present invention.

FIGS. 4A and 4B show diagrams for illustrating the control in a power supply device according to a further embodiment of the present invention.

FIG. 5 shows a flow chart of a method for supplying power to a radar sensor according to one embodiment of the present invention.

### DETAILED DESCRIPTION OF EXAMPLE EMBODIMENTS

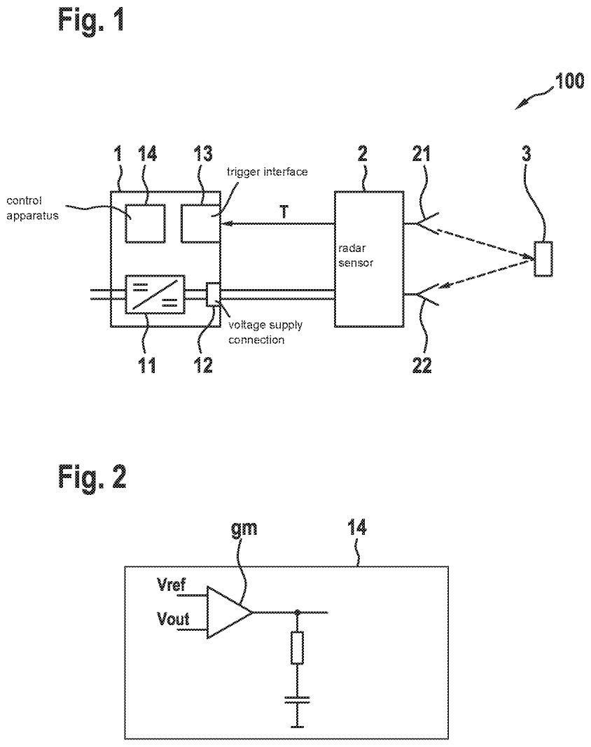

FIG. 1 shows a block diagram of a radar system 100 comprising a power supply device 1 according to one embodiment. For example, such a radar system 100 can be used to detect objects 3 in a field of view of the radar system 100. The radar system 100 can, for example, determine the distance, azimuth and/or elevation position and, if necessary, relative velocity for one or more detected objects 3. Such information can be used, for example, by components of a vehicle for fully or at least partially autonomous driving and for driver assistance systems. In principle, however, any other applications for such a radar system 100 are also possible.

The radar system 100 comprises a radar sensor 2 and a power supply device 1 for the radar sensor 2. The radar sensor 2 can generate radar signals and transmit them via a transmitting antenna 21. The transmitted radar signals can hit an object 3 and be at least partially scattered by it. Some of the radar signals reflected by the object 3 can be received and evaluated by a receiving antenna 22 of the radar sensor 2. In particular, the radar sensor 2 can transmit radar signals in a first time interval. This can be followed by a second time interval, in which no radar signals are transmitted. The first intervals for transmission and the second intervals in which no radar signals are transmitted can be repeated regularly, for example periodically. For example, the radar sensor 2 can be a radar sensor that operates as a frequency-modulated continuous wave radar.

To supply power to the radar sensor 2, the power supply device 1 can provide a suitable supply voltage Vin at the radar sensor 2. For example, a voltage converter 11, in particular a switching converter or the like, can be provided in the power supply device 1. This voltage converter 11 can convert an electrical voltage provided at the input of the power supply device 1 into a further voltage that meets the requirements for the input voltage of the radar sensor 2. In particular, a control apparatus 14 which regulates the output voltage of the voltage converter 11 in accordance with one or more setpoint specifications can be provided in the power supply device 1 for this purpose.

Thus, the voltage converter 11 provides an electrical voltage at a voltage supply connection 12, which voltage is suitable for supplying the radar sensor 2 with electrical energy.

The radar sensor 2 can also, at the power supply device 1, signal a switch from a state in which no radar signals are transmitted to a state in which radar signals are transmitted. For example, the radar sensor 2 can output a trigger signal T that, for example, signals the switch of operating state in the radar sensor 2 shortly prior to the commencement of the transmission of radar signals. Such a trigger signal T can, for example, be received at a trigger interface 13 of the power supply device 1. Since the energy requirement in the radar sensor 2 increases when the radar signals are transmitted by the radar sensor 2, such an increase in the power requirement in the radar sensor 2 is known in advance by the signaling by means of the trigger signal T of the power supply device 1. Thus, after receiving such a trigger signal T, it is possible to actively intervene in the control circuit of the power supply device 1 in order to counteract excessive fluctuations in the supply voltage for the radar sensor 2 when starting to transmit the radar signals. Some exemplary approaches for this are explained in more detail below.

The intervention in the control behavior of the power supply device 1 after receiving the trigger signal T is only temporary, i.e. for a short period of time. Subsequently, the control can be reset to its initial setting.

Such an intervention in the control behavior of the power supply device 1 after receiving a trigger signal T from the radar sensor 2 can thus provide a voltage supply for the radar sensor 2, which ensures a supply voltage that remains within specified tolerances even in the event of a rapid increase in current consumption when the transmission of radar signals is started, in order to enable the reliable and trouble-free operation of the radar sensor 2. This can improve the operating behavior of the radar sensor 2. In particular, faulty detections due to a voltage drop in the voltage supply can be avoided.

FIG. 2 shows a schematic representation of a principle circuit diagram of components within the control apparatus 14 of the power supply device 1 according to one embodiment. To control the output voltage Vout of the power supply device 1, in particular the voltage converter 11, an error amplifier gm, for example a transconductance amplifier, can compare a reference voltage Vref with the output voltage Vout on the input side. As an output value, this error amplifier can output a control variable that corresponds to the difference between the reference voltage Vref and the output voltage Vout. On the basis of the output signal of such an error amplifier gm, the control of the voltage converter 11 can thereupon be adjusted in order to set the output voltage Vout to the specified reference voltage Vref.

As will be explained in more detail below, the value of the reference voltage Vref can either be temporarily adjusted on the basis of the trigger signal T or, for example, the control bandwidth of the error amplifier gm can be adjusted.

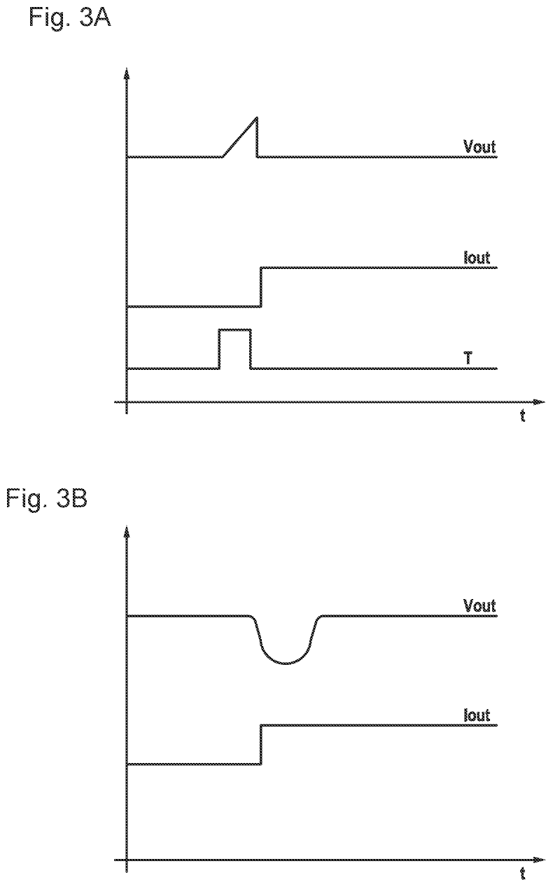

FIG. 3A shows a schematic representation of the control behavior according to one embodiment. As can be seen here, for example, the output voltage Vout of the power supply device 1 can be temporarily increased in response to the reception of a trigger signal T from the radar sensor 2. For example, the reference voltage Vref can be increased for a specified period of time after the trigger signal T has been received. The output voltage Vout is increased in such a way that the increased output voltage Vout is still within a permissible range for the supply voltage of the radar sensor 2. In particular, if, for example, a capacitor is provided at the output of the power supply device 1 to stabilize the output voltage Vout, this capacitor is also charged to the increased output voltage Vout. Thus, this capacitor stores a larger amount of energy, which can be called up by the radar sensor 2. As a result, the supply voltage for the radar sensor 2 will not drop excessively upon the start of the generation of radar signals, so that a sufficient power supply for the radar sensor 2 can always be ensured.

In FIG. 3, Vout represents the course of the output voltage, Iout the course of the electrical current from the power supply device 1 to the radar sensor 2, and T the trigger signal output by the radar sensor.

FIG. 3B shows the control behavior of a conventional system for comparison. As can be seen here, the supply voltage Vout can initially drop significantly when the current consumption increases. Under unfavorable conditions, this can impair the functionality of the radar sensor 2.

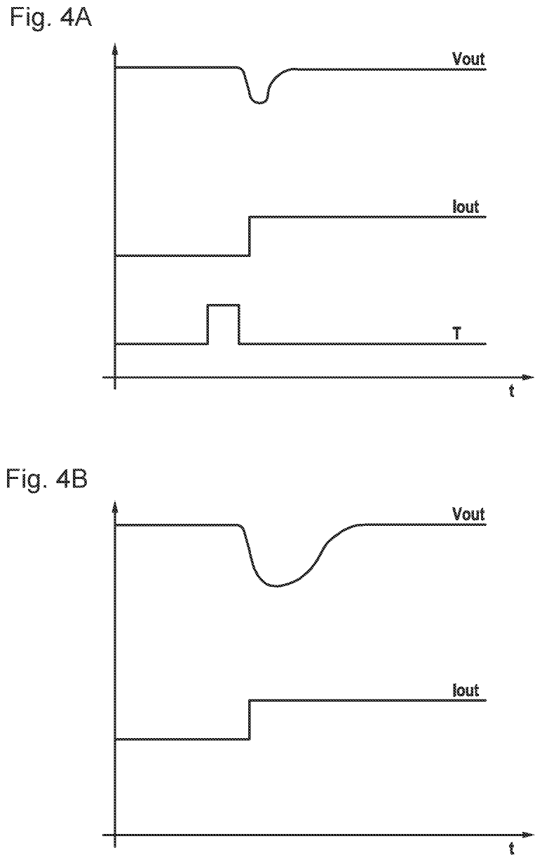

FIG. 4A shows a schematic representation of the course of output voltage Vout, output current and trigger signal T according to a further embodiment. After receiving the trigger signal T, the control bandwidth is temporarily increased to control the output voltage Vout. For example, this can be achieved by connecting additional error amplifiers gm in parallel. In addition or as an alternative, any other measures for temporarily increasing the control bandwidth are of course also possible. This makes it possible to counteract a voltage drop due to an increase in the current consumption of the radar sensor 2 more rapidly. Consequently, the voltage drop in the supply voltage Vout will be lower with an increased control bandwidth than it would be in the conventional case.

After a predetermined period of time, the increased control bandwidth can be reset, such that, in the further course, the output voltage Vout can be readjusted with the initial control bandwidth. In this way, the stability of the control for the output voltage Vout can be increased.

FIG. 4B shows the voltage of a conventional system for comparison, in which the control bandwidth is not adjusted.

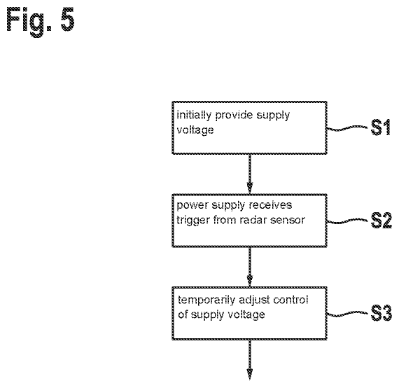

FIG. 5 shows a flow chart of a method for supplying power to a radar sensor 2 according to one embodiment. The method according to the present invention can be carried out, for example, by means of the power supply device 1 described above. In principle, the method can comprise any of the steps already described above in connection with the power supply device 1. The device components described above can also be designed to carry out the method steps described below.

In a step S1, a supply voltage Vout is initially provided at the radar sensor 2. The output voltage can be set to a predetermined voltage value Vout and regulated with a specified control bandwidth.

In step S2, the power supply device 1 receives a trigger signal T from the radar sensor 2. This trigger signal can, for example, signal an expected increased power requirement of the radar sensor 2. For example, the radar sensor 2 can signal, by means of the trigger signal, that the transmission of radar signals will commence shortly.

Thereupon, the control of the supply voltage for the radar sensor 2 can be temporarily adjusted in step S3. As described above, the adjustment of the control can comprise, for example, a temporary increase in the voltage level of the supply voltage for the radar sensor 2. Additionally or alternatively, it is also possible, for example, to temporarily increase the control bandwidth of the control for the output voltage.

The temporary adjustment of the control behavior for the output voltage of the power supply device 1 can be terminated after a predetermined period of time. Thereupon, there can be a return to the initial output voltage and/or the initial control bandwidth.

In summary, the present invention relates to a power supply for a radar sensor that periodically transmits sequences with radar signals. Prior to the commencement of the transmission of radar signals, the radar sensor can provide a trigger signal at a power supply device, whereupon the power supply device temporarily adjusts the control behavior for the supply voltage of the radar sensor.

1-10. (canceled)

11. A power supply device for a radar sensor, comprising:
a voltage supply connection, wherein the power supply device is configured to provide a supply voltage for the radar sensor at the voltage supply connection;
an input interface configured to receive a trigger signal from the radar sensor; and
a control apparatus configured to temporarily adjust a control for the supply voltage at the voltage supply connection when the trigger signal from the radar sensor has been received at the input interface.

12. The power supply device according to claim 11, further comprising:
a switching converter configured to convert an input voltage provided at the power supply device into an output voltage and to provide the output voltage as a supply voltage at the voltage supply connection.

13. The power supply device according to claim 11, wherein the control apparatus is configured to increase the supply voltage at the voltage supply connection when the trigger signal from the radar sensor has been received at the input interface.

14. The power supply device according to claim 11, wherein the control apparatus is configured to increase a control bandwidth of the control for the supply voltage at the voltage supply connection when a trigger signal from the radar sensor has been received at the input interface.

15. The power supply device according to claim 14, wherein the control apparatus is configured to reset the control bandwidth of the control for the supply voltage at the voltage supply connection after a predetermined period of time after the control bandwidth has been increased.

16. A radar system, comprising:
a radar sensor configured to transmit radar signals, receive radar echoes of the transmitted radar signals, and process the received radar echoes; and
a power supply device for the radar sensor wherein the power supply device being configured to provide a supply voltage for the radar sensor, the power supply device including:
a voltage supply connection, wherein the power supply device is configured to provide the supply voltage for the radar sensor at the voltage supply connection,
an input interface configured to receive a trigger signal from the radar sensor; and
a control apparatus configured to temporarily adjust a control for the supply voltage at the voltage supply connection when the trigger signal from the radar sensor has been received at the input interface;
wherein the radar sensor is configured to provide the trigger signal at the input interface of the power supply device when a specified operating state is set in the radar sensor.

17. The radar system according to claim 16, wherein the radar sensor is configured to transmit sequences of radar signals, wherein pauses in which no radar signals are transmitted are provided between the sequences of radar signals, and wherein the radar sensor is configured to provide the trigger signal at the input interface of the power supply device in each case prior to the transmission of a sequence of radar signals.

18. The radar system according to claim 16, wherein the radar sensor includes a frequency-modulated continuous wave radar.

19. A motor vehicle, comprising:
a radar system, including:
a radar sensor configured to transmit radar signals, receive radar echoes of the transmitted radar signals, and process the received radar echoes; and
a power supply device for the radar sensor wherein the power supply device being configured to provide a supply voltage for the radar sensor, the power supply device including:
a voltage supply connection, wherein the power supply device is configured to provide the supply voltage for the radar sensor at the voltage supply connection,
an input interface configured to receive a trigger signal from the radar sensor; and
a control apparatus configured to temporarily adjust a control for the supply voltage at the voltage supply connection when the trigger signal from the radar sensor has been received at the input interface;
wherein the radar sensor is configured to provide the trigger signal at the input interface of the power supply device when a specified operating state is set in the radar sensor.

20. A method for supplying power to a radar sensor, comprising the following steps:
providing a supply voltage at the radar sensor;
receiving a trigger signal from the radar sensor; and
temporarily adjusting a control for the supply voltage at the radar sensor when a trigger signal from the radar sensor has been received.
